(19) United States
(12) Patent Application Publication
(10) Pub. No.: US 2017/0126128 A1
(43) Pub. Date: May 4, 2017

(54) BOOST CONVERTER AND THE METHOD THEREOF

(71) Applicant: Monolithic Power Systems Co., Inc., San Jose, CA (US)

(72) Inventor: Yike Li, Chengdu (CN)

(21) Appl. No.: 15/338,206

(22) Filed: Oct. 28, 2016

(30) Foreign Application Priority Data
Oct. 28, 2015 (CN) 201510715743.1

(51) Int. Cl. H02M 3/158; H02M 1/08

(52) U.S. Cl. CPC H02M 3/158; H02M 1/08; H02M 2001/0009

(57) ABSTRACT

A boost converter having an inductor having a first terminal coupled to an input port to receive the input voltage; a high side switch coupled between the inductor and an output port; a low side switch coupled between the inductor and a ground reference; and a control circuit configured to receive a feedback signal indicative of the output voltage and a reference signal, and to provide a high side control signal and a low side control signal based on the feedback signal and the reference signal; wherein the low side switch on time period is controlled to be constant by the low side control signal.

### CROSS-REFERENCE TO RELATED APPLICATIONS

This application claims priority to and the benefit of Chinese Patent Application No. 201510715743.1, filed on Oct. 28, 2015, which is incorporated herein by reference in its entirety.

### FIELD

The present invention relates generally to electronic circuits, and more particularly but not exclusively to boost converters and the method thereof.

### BACKGROUND

Peak current mode control is widely adopted in conventional boost converters. However, there is a compromise between bandwidth and steady requirement in boost converter with peak current mode control. In other words, the transient response of the conventional boost converter with peak current mode control is usually slow.

As a result, there is a need for boost converter with high bandwidth and simple circuit.

### SUMMARY

It is an object of the present invention to provide a boost converter with constant on time control so as to achieve high bandwidth and simple structure.

In accomplishing the above and other objects, there has been provided, in accordance with an embodiment of the present invention, a boost converter, comprising: an input port configured to receive an input voltage; an output port configured to provide an output voltage; an inductor having a first terminal coupled to the input port to receive the input voltage; a high side switch having a first terminal coupled to a second terminal of the inductor, a second terminal coupled to the output port, and a control terminal configured to receive a high side control signal; a low side switch having a first terminal coupled to the second terminal of the inductor, a second terminal coupled to a ground reference, and a control terminal configured to receive a low side control signal; and a control circuit having a first input terminal configured to receive a feedback signal indicative of the output voltage, a second input terminal configured to receive a reference signal, a first output terminal and a second output terminal respectively provide the high side control signal and the low side control signal based on the feedback signal and the reference signal; wherein the low side switch on time period is controlled to be constant by the low side control signal.

In accomplishing the above and other objects, there has been provided, in accordance with an embodiment of the present invention, a control circuit for a boost converter having a high side switch, a low side switch and an inductor, comprising: a feedback amplifier having a first input terminal configured to receive a reference signal, a second input terminal configured to receive a feedback signal indicative of an output voltage of the boost converter, and an output terminal configured to provide a voltage control signal based on the reference signal and the feedback signal; a comparator having a first input terminal configured to receive a current sense signal indicative of a current flowing through the high side switch, a second input terminal coupled to the output terminal of the feedback amplifier to receive the voltage control signal, and an output terminal configured to provide an on trigger signal based on the current sense signal and the voltage control signal; a constant on time control circuit having an input terminal configured to receive a low side control signal controlling the low side switch, and an output terminal configured to provide an off trigger signal based on the low side control signal; and a logic circuit having a first input terminal coupled to the output terminal of the comparator to receive the on trigger signal, a second input terminal coupled to the output terminal of the constant on time control circuit to receive the off trigger signal, a first output terminal and a second output terminal configured to respectively provide the high side control signal and the low side control signal based on the on trigger signal and the off trigger signal; wherein the low side switch on time period is controlled to be constant by the low side control signal, and wherein the low side switch on time period is initiated by the on trigger signal, and is terminated by the off trigger signal.

In accomplishing the above and other objects, there has been provided, in accordance with an embodiment of the present invention, a method of controlling a boost converter, wherein the boost converter converting an input voltage to an output voltage, and the boost converter having an inductor, a high side switch coupled between the inductor and the output voltage, a low side switch coupled between the inductor and a ground reference, the method comprising: generating a voltage control signal based on an error between a reference signal and a feedback signal indicative of the output voltage; generating an on trigger signal based on a comparison result of the voltage control signal and a current sense signal indicative of a current flowing through the high side switch; generating a low side control signal based on the on trigger signal and an off trigger signal; generating the off trigger signal based on the low side control signal; and controlling the low side switch by the low side control signal; wherein the low side switch on time period is controlled to be constant by the low side control signal.

The presented boost converter has high bandwidth and simple circuit structure. Furthermore, the presented boost converter has high efficiency under light load condition.

### BRIEF DESCRIPTION OF THE DRAWINGS

FIG. 1 schematically shows a boost converter 10 in accordance with an embodiment of the present invention.

FIG. 2 shows waveforms of signals of the boost converter 10 in FIG. 1.

FIG. 3 schematically shows a boost converter 30 in accordance with an embodiment of the present invention.

FIG. 4 schematically shows a boost converter 40 in accordance to an embodiment of the present invention.

FIG. 5 shows a flow chart of control method 50 for boost converters in accordance with an embodiment of the present invention.

The use of the same reference label in different drawings indicates the same or like components.

### DETAILED DESCRIPTION

In the present invention, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

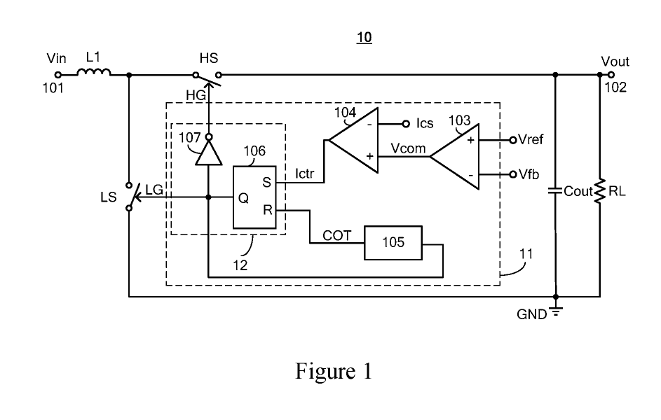

FIG. 1 schematically shows a boost converter 10 in accordance with an embodiment of the present invention. As shown in FIG. 1, the boost converter 10 comprises: an input port 101 configured to receive an input voltage Vin; an output port 102 configured to provide an output voltage Vout; an inductor L1 having a first terminal and a second terminal, wherein the first terminal is coupled to the input port 101 to receive the input voltage Vin; a high side switch HS having a first terminal, a second terminal and a control terminal, wherein the first terminal is coupled to the second terminal of the inductor L1, the second terminal is coupled to the output port 102, and the control terminal is configured to receive a high side control signal HG; a low side switch LS having a first terminal, a second terminal and a control terminal, wherein the first terminal is coupled to the second terminal of the inductor L1, the second terminal is coupled to a ground reference GND, and the control terminal is configured to receive a low side control signal LG; and a control circuit 11 having a first input terminal, a second input terminal, a first output terminal and a second output terminal, wherein the first input terminal is configured to receive a feedback signal Vfb indicative of the output voltage Vout, the second input terminal is configured to receive a reference signal Vref, and wherein based on the feedback signal Vfb and the reference signal Vref, the control circuit 11 provides the high side control signal HG at the first output terminal and provides the low side control signal LG at the second output terminal, and wherein the low side switch LS on time period Ton is controlled to be constant by the low side control signal LG.

As shown in FIG. 1, the boost converter 10 further comprises an output capacitor Cout coupled between the output port 102 and the ground reference GND. Meanwhile, a load of the boost converter 10 is represented by a resistor RL.

The high side switch HS and the low side switch LS comprise any controllable semiconductor device, e.g., MOSFET (Metal Oxide Semiconductor Field Effect Transistor), BJT (Bipolar Junction Transistor) and so on.

In one embodiment, the control circuit 11 further comprises a third input terminal configured to receive a current sense signal Ics indicative of a current flowing through the high side switch HS.

In one embodiment, the control circuit 11 comprises: a feedback amplifier 103 having a first input terminal (non-inverting terminal), a second input terminal (inverting terminal) and an output terminal, wherein the first input terminal is configured to receive the reference signal Vref, the second input terminal is configured to receive the feedback signal Vfb, and wherein based on the reference signal Vref and the feedback signal Vfb, the feedback amplifier 103 provides a voltage control signal Vcom indicative of an error between the reference signal Vref and the feedback signal Vfb at the output terminal; a comparator 104 having a first input terminal (inverting terminal), a second input terminal (non-inverting terminal) and an output terminal, wherein the first input terminal is configured to receive the current sense signal Ics, the second input terminal is coupled to the output terminal of the feedback amplifier 103 to receive the voltage control signal Vcom, and wherein based on the current sense signal Ics and the voltage control signal Vcom, the comparator 104 provides an on trigger signal Ictr at the output terminal; a constant on time control circuit 105 having an input terminal and an output terminal, wherein the input terminal is configured to receive the low side control signal LG, and wherein based on the low side control signal LG, the constant on time control circuit 105 provides an off trigger signal COT at the output terminal; and a logic circuit 12 having a first input terminal, a second input terminal, a first output terminal and a second output terminal, wherein the first input terminal is coupled to the output terminal of the comparator 104 to receive the on trigger signal Ictr, the second input terminal is coupled to the output terminal of the constant on time control circuit 105 to receive the off trigger signal COT, and wherein based on the on trigger signal Ictr and the off trigger signal COT, the logic circuit 12 provides the high side control signal HG at the first output terminal, and provides the low side control signal LG at the second output terminal, wherein the low side switch LS on time period Ton is controlled to be constant by the low side control signal LG, and wherein the low side switch LS on time period Ton is initiated by the on trigger signal Ictr, and is terminated by the off trigger signal COT.

In one embodiment, the logic circuit 12 comprises: a RS flip-flop 106 having a set terminal “S”, a reset terminal “R” and an output terminal “Q”, wherein the set terminal “S” is coupled to the output terminal of the comparator 104 to receive the on trigger signal Ictr, and the reset terminal “R” is coupled to the output terminal of the constant on time control circuit 105 to receive the off trigger signal COT, and wherein based on the on trigger signal Ictr and the off trigger signal COT, the RS flip-flop 106 provides the low side control signal LG at the output terminal “Q”; and an inverter 107 having an input terminal and an output terminal, wherein the input terminal is coupled to the output terminal “Q” of the RS flip-flop 106 to receive the low side control signal LG, and wherein based on the low side control signal LG, the inverter 107 provides the high side control signal HS at the output terminal, wherein the high side control signal HS has an opposite phase with the low side control signal LG. In one embodiment, the logic circuit 12 further comprises a dead time control circuit (not shown in FIG. 3). The dead time control circuit controls the high side switch HS and low side switch LS being off for a preset dead time period after the high side switch HS is turned off, or after the low side switch LS is turned off.

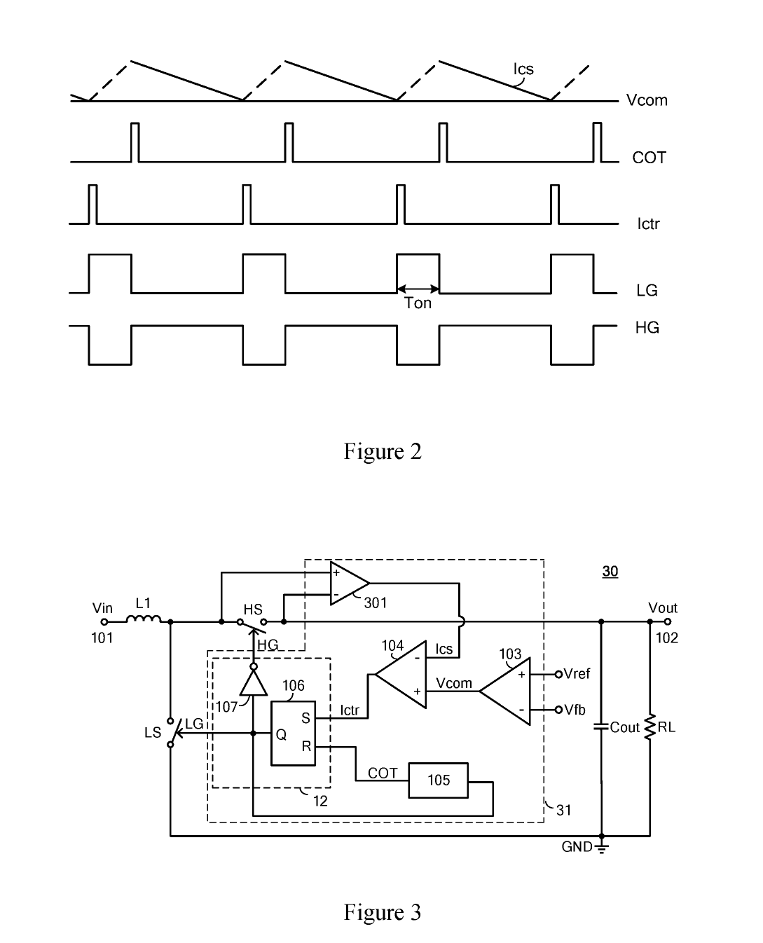

FIG. 2 shows waveforms of signals of the boost converter 10 in FIG. 1. The operation of the boost converter 10 is described referring to FIGS. 1 and 2. The high side switch HS and the low side switch LS are turned on and off alternatively. During when the high side switch HS is on and the low side switch LS is off, the current flowing through the high side switch HS decreases, so as the current sense signal Ics. When the current sense signal Ics decreases to the voltage control signal Vcom, the comparator 104 flips and provides the on trigger signal Ictr to set the RS flip-flop 106. As a result, the RS flip-flop 106 outputs the low side control signal LG to turn on the low side switch LS. Meanwhile, the inverter 107 outputs the high side control signal HG to turn off the high side switch HS. After that, the current flowing through the inductor L1, i.e., a current flowing through the low side switch LS, increases. After the constant time period Ton, the constant on time control circuit 105 provides the off trigger signal COT to reset the RS flip-flop 106. As a result, the RS flip-flop 106 outputs the low side control signal LG to turn off the low side switch LS. Meanwhile, the inverter 107 outputs the high side control signal HG to turn on the high side switch HS. After that, the current flowing through the inductor L1, i.e., the current flowing through the high side switch HS, decreases. When the current sense signal Ics indicative of the current flowing through the high side switch HS decreases to the voltage control signal Vcom, the comparator 104 flips and provides the on trigger signal Ictr to set the RS flip-flop 106 again, and the operation repeats.

In the embodiment of FIG. 1, the constant on time control circuit 105 receives the low side control signal LG, wherein based on the low side control signal LG, the constant on time control circuit 105 provides the off trigger signal COT to reset the RS flip-flop 106 after the constant time period Ton from the instant the low side switch LS is turned on. In one embodiment, the constant on time control circuit 105 may comprise a timing circuit. The constant on time control circuit 105 may be implemented by digital circuit or analog circuit, and is known to persons of ordinary skill in the art.

In one embodiment, the on trigger signal Ictr and the off trigger signal COT are pulse signals as shown in FIG. 2. The off trigger signal COT has a pulse after a constant time period Ton from the pulse of the on trigger signal Ictr. Thus, the pulse of the on trigger signal Ictr determines the start time of the constant time period Ton, and the off trigger signal COT determines the end time of the constant time period Ton.

FIG. 3 schematically shows a boost converter 30 in accordance with an embodiment of the present invention. Compared with boost converter 10 in FIG. 1, a control circuit 31 of the boost converter 30 further comprises a current sense amplifier 301 having a first input terminal (non-inverting terminal), a second input terminal (inverting terminal) and an output terminal, wherein the first input terminal is coupled to a connection node of the inductor L1 and the high side switch HS, and the second input terminal is coupled to a connection node of the high side switch HS and the output voltage Vout, and wherein based on a voltage drop across the high side switch HS, the current sense amplifier 301 provides the current sense signal Ics at the output terminal.

Persons of ordinary skill in the art should know that, the current flowing through the high side switch HS causes the voltage drop across the high side switch HS. The value of the voltage drop across the high side switch HS is a product of the current flowing through the high side switch HS and an equivalent on resistor of the high side switch HS. The current sense amplifier 301 is configured to generate the current sense signal Ics indicating the current flowing through the high side switch HS by amplifying the voltage drop across the high side switch HS.

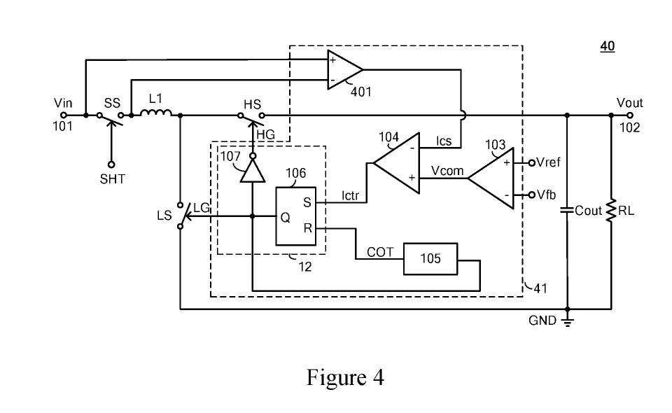

FIG. 4 schematically shows a boost converter 40 in accordance to an embodiment of the present invention. Compared to the boost converter 10 in FIG. 1, the boost converter 40 further comprises a cut-out switch SS coupled between the input voltage Vin and the inductor L1. Accordingly, a current sense amplifier 401 in the boost converter 40 has a first input terminal, a second input terminal and an output terminal, wherein the first input terminal is coupled to a connection node of the cut-out switch SS and the input voltage Vin, and the second input terminal is coupled to a connection node of the cut-out switch SS and the inductor L1, and wherein based on a voltage drop across the cut-out switch SS, the current sense amplifier 401 generates the current sense signal Ics at the output terminal.

During a normal working status, the cut-out switch SS is on and the inductor boost converter is connected to the input voltage Vin. As can be seen from FIG. 4, a current flowing through the cut-out switch SS also flows through the inductor L1. Thus, a voltage drop across the cut-out switch SS is a product of an equivalent on resistor of the cut-out switch SS and the current flowing through the cut-out switch SS, i.e., the current flowing through the inductor L1. The current sense amplifier 401 amplifies the voltage drop across the cut-out switch SS to generate the current sense signal Ics indicative of the current flowing through the inductor L1. Obviously, during when the high side switch HS is on, the current flowing through the inductor L1 is equal to the current flowing through the high side switch HS. Thus, the current sense signal Ics also indicates the current flowing through the high side switch HS during when the high side switch HS is on.

When the output port 102 of the boost converter 40 is shorted to the ground reference GND, the cut-out switch SS will be turned off by a short alert signal SHT. As a result, the inductor L1 is disconnected from the input port 101, and so is the boost converter 40. The short alert signal SHT could be produced by multiple methods known to persons of ordinary skill in the art, and is not described here for brevity.

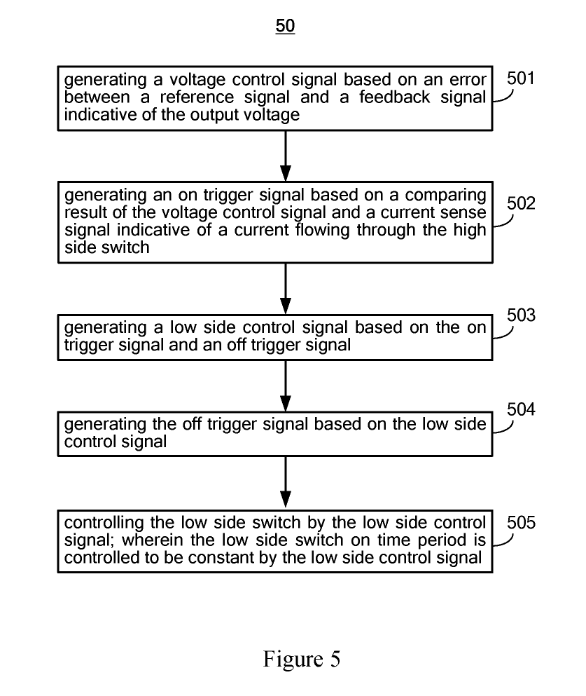

FIG. 5 shows a flow chart of a method 50 for controlling a boost converter in accordance with an embodiment of the present invention. The boost converter converts an input voltage to a desired output voltage. The boost converter may comprise an inductor, a high side switch coupled between the inductor and the output voltage, and a low side switch coupled between the inductor and a ground reference. The control method 50 comprises: step 501, generating a voltage control signal based on an error between a reference signal and a feedback signal indicative of the output voltage; step 502, generating an on trigger signal based on a comparing result of the voltage control signal and a current sense signal indicative of a current flowing through the high side switch; step 503, generating a low side control signal based on the on trigger signal and an off trigger signal; step 504, generating the off trigger signal based on the low side control signal; and step 505, controlling the low side switch by the low side control signal; wherein the low side switch on time period is controlled to be constant by the low side control signal.

In one embodiment, the method 50 further comprises generating the current sense signal by detecting a voltage drop across the high side switch.

In one embodiment, the boost converter further comprises a cut-out switch coupled between the input voltage and the inductor. Accordingly, the method 50 further comprises generating the current sense signal by detecting a voltage drop across the cut-out switch.

The present invention provides boost converters without current loop. Meanwhile, the presented boost converter has a high bandwidth promising excellent performance during load transient.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A boost converter, comprising:
an input port configured to receive an input voltage;
an output port configured to provide an output voltage;
an inductor having a first terminal coupled to the input port to receive the input voltage;
a high side switch having a first terminal coupled to a second terminal of the inductor, a second terminal coupled to the output port, and a control terminal configured to receive a high side control signal;
a low side switch having a first terminal coupled to the second terminal of the inductor, a second terminal coupled to a ground reference, and a control terminal configured to receive a low side control signal; and
a control circuit having a first input terminal configured to receive a feedback signal indicative of the output voltage, a second input terminal configured to receive a reference signal, a first output terminal and a second output terminal respectively provide the high side control signal and the low side control signal based on the feedback signal and the reference signal; wherein
the low side switch on time period is controlled to be constant by the low side control signal.

2. The boost converter of claim 1, wherein the control circuit further comprises a third input terminal configured to receive a current sense signal indicative of a current flowing through the high side switch, and wherein based on the current sense signal, the feedback signal and the reference signal, the control circuit provides the high side control signal to control the high side switch, and provides the low side control signal to control the low side switch.

3. The boost converter of claim 2, wherein the control circuit comprises:
a feedback amplifier having a first input terminal, a second input terminal and an output terminal, wherein the first input terminal is configured to receive the reference signal, the second input terminal is configured to receive the feedback signal, and the output terminal is configured to provide a voltage control signal indicative of an error between the reference signal and the feedback signal;
a comparator having a first input terminal, a second input terminal and an output terminal, wherein the first input terminal is configured to receive the current sense signal, the second input terminal is coupled to the output terminal of the feedback amplifier to receive the voltage control signal, and the output terminal is configured to provide an on trigger signal based on the current sense signal and the voltage control signal;
a constant on time control circuit having an input terminal and an output terminal, wherein the input terminal is configured to receive the low side control signal, and the output terminal is configured to provide an off trigger signal based on the low side control signal; and
a logic circuit having a first input terminal, a second input terminal, a first output terminal and a second output terminal, wherein the first input terminal is coupled to the output terminal of the comparator to receive the on trigger signal, the second input terminal is coupled to the output terminal of the constant on time control circuit to receive the off trigger signal, the first output terminal and the second output terminal are configured to respectively provide the high side control signal and the low side control signal based on the on trigger signal and the off trigger signal; wherein
the low side switch on time period is initiated by the on trigger signal, and is terminated by the off trigger signal.

4. The boost converter of claim 3, wherein the control circuit further comprises a current sense amplifier having a first input terminal, a second input terminal and an output terminal, wherein the first input terminal is coupled to a connection node of the inductor and the high side switch, the second input terminal is coupled to a connection node of the high side switch and the output port, and the output terminal is configured to provide the current sense signal indicative of the current flowing through the high side switch based on a voltage drop across the high side switch.

5. The boost converter of claim 1, further comprising a cut-out switch coupled between the input port and the inductor, wherein the cut-out switch is turned off when the output port of the boost converter is shorted to the ground reference, so as to disconnect the boost converter from the input voltage.

6. The boost converter of claim 5, wherein the control circuit comprises:
a feedback amplifier having a first input terminal, a second input terminal and an output terminal, wherein the first input terminal is configured to receive the reference signal, the second input terminal is configured to receive the feedback signal, and the output terminal is configured to provide a voltage control signal based on the reference signal and the feedback signal;
a current sense amplifier having a first input terminal, a second input terminal and an output terminal, wherein the first input terminal is coupled to a connection node of the cut-out switch and the input port, the second input terminal is coupled to a connection node of the cut-out switch and the inductor, and the output terminal is configured to provide a current sense signal indicative of a current flowing through the cut-out switch based on a voltage drop across the cut-out switch;
a comparator having a first input terminal, a second input terminal and an output terminal, wherein the first input terminal is coupled to the output terminal of the current sense amplifier to receive the current sense signal, the second input terminal is coupled to the output terminal of the feedback amplifier to receive the voltage control signal, and the output terminal is configured to provide an on trigger signal based on the current sense signal and the voltage control signal;
a constant on time control circuit having an input terminal and an output terminal, wherein the input terminal is configured to receive the low side control signal, and the output terminal is configured to provide an off trigger signal based on the low side control signal; and
a logic circuit having a first input terminal, a second input terminal, a first output terminal and a second output terminal, wherein the first input terminal is coupled to the output terminal of the comparator to receive the on trigger signal, the second input terminal is coupled to the output terminal of the constant on time control circuit to receive the off trigger signal, the first output terminal and the second output terminal are configured to respectively provide the high side control signal and the low side control signal based on the on trigger signal and the off trigger signal; wherein
the low side switch on time period is initiated by the on trigger signal, and is terminated by the off trigger signal.

7. A control circuit for a boost converter having a high side switch, a low side switch and an inductor, comprising:
a feedback amplifier having a first input terminal configured to receive a reference signal, a second input terminal configured to receive a feedback signal indicative of an output voltage of the boost converter, and an output terminal configured to provide a voltage control signal based on the reference signal and the feedback signal;
a comparator having a first input terminal configured to receive a current sense signal indicative of a current flowing through the high side switch, a second input terminal coupled to the output terminal of the feedback amplifier to receive the voltage control signal, and an output terminal configured to provide an on trigger signal based on the current sense signal and the voltage control signal;
a constant on time control circuit having an input terminal configured to receive a low side control signal controlling the low side switch, and an output terminal configured to provide an off trigger signal based on the low side control signal; and
a logic circuit having a first input terminal coupled to the output terminal of the comparator to receive the on trigger signal, a second input terminal coupled to the output terminal of the constant on time control circuit to receive the off trigger signal, a first output terminal and a second output terminal configured to respectively provide the high side control signal and the low side control signal based on the on trigger signal and the off trigger signal; wherein
the low side switch on time period is controlled to be constant by the low side control signal, and wherein the low side switch on time period is initiated by the on trigger signal, and is terminated by the off trigger signal.

8. The control circuit of claim 7, further comprising a current sense amplifier having a first input terminal and a second input terminal coupled respectively to a first terminal and a second terminal of the high side switch to detect a voltage drop across the high side switch, and an output terminal configured to provide the current sense signal based on a voltage drop across the high side switch.

9. The control circuit of claim 7, wherein the boost converter further comprises a cut-out switch coupled between the inductor and an input voltage of the boost converter, and wherein the control circuit further comprises a current sense amplifier having a first input terminal coupled to a connection node of the cut-out switch and the input voltage, a second input terminal coupled to a connection node of the cut-out switch and the inductor, and an output terminal configured to provide the current sense signal based on the voltage drop across the cut-out switch.

10. A method of controlling a boost converter, wherein the boost converter converting an input voltage to an output voltage, and the boost converter having an inductor, a high side switch coupled between the inductor and the output voltage, a low side switch coupled between the inductor and a ground reference, the method comprising:
generating a voltage control signal based on an error between a reference signal and a feedback signal indicative of the output voltage;
generating an on trigger signal based on a comparison result of the voltage control signal and a current sense signal indicative of a current flowing through the high side switch;
generating a low side control signal based on the on trigger signal and an off trigger signal;
generating the off trigger signal based on the low side control signal; and
controlling the low side switch by the low side control signal; wherein the low side switch on time period is controlled to be constant by the low side control signal.

11. The method of claim 10, further comprising generating the current sense signal by detecting a voltage drop across the high side switch.

12. The method of claim 10, wherein the boost converter further comprises a cut-out switch coupled between the input voltage and the inductor, and wherein the method further comprises generating the current sense signal by detecting a voltage drop across the cut-out switch.
